(19) United States
(12) Patent Application Publication
(10) Pub. No.: US 2010/0156739 A1
(43) Pub. Date: Jun. 24, 2010

(54) APPARATUS FOR REDUCING ELECTROMAGNETIC WAVES AND METHOD THEREOF

(75) Inventors: Sang Il KWAK, Daejeon (KR); Jong Hwa Kwon, Daejeon (KR); Dong-Uk Sim, Daejeon (KR); Je Hoon Yun, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/634,342

(22) Filed: Dec. 9, 2009

(30) Foreign Application Priority Data
Dec. 22, 2008 (KR) 10-2008-0130775

(51) Int. Cl. H01Q 1/52

(52) U.S. Cl. 343/841

(57) ABSTRACT

An apparatus for reducing electromagnetic waves includes a dielectric layer and a plurality of metal unit cells periodically formed over the dielectric layer. The apparatus further includes an adhesive formed under the dielectric layer for attaching the apparatus to a radiator radiating electromagnetic waves.

### CROSS-REFERENCE(S) TO RELATED APPLICATION(S)

The present invention claims priority of Korean Patent Application No. 10-2008-0130775, filed on Dec. 22, 2008, which is incorporated herein by reference.

### FIELD OF THE INVENTION

The present invention relates to an apparatus and method for reducing electromagnetic waves, and, more specifically, an apparatus for reducing electromagnetic waves and method thereof capable of being attached to radiators.

### BACKGROUND OF THE INVENTION

Recently, with a rapid development of information technology (IT) and increasing desire for communication, wireless communication devices such as mobile terminals has become a necessaries of the moderners. However, as the use of the wireless communication devices is increasing, an influence of electromagnetic waves generated by the devices on a human body is becoming important issue. For now, the relation between electromagnetic waves and a human body influenced thereby is not clearly found out, but, it has been reported that there is a possibility for electromagnetic waves to cause various diseases such as leukemia, brain tumor, headache, and amblyopia. Also, when electromagnetic waves are accumulated in the human body, confusion of brain waves and destruction of the generative function of males may occur. Accordingly, many researches for preventing the negative influence of electromagnetic waves on a human body by blocking electromagnetic waves are being conducted.

As conventional technologies for reducing an influence of electromagnetic waves, there are a technology using an electromagnetic bandgap (EBG), a technology using an electromagnetic absorber, and a technology using structural unconformity of a radiator.

The technology using an EBG changes an inherent electromagnetic characteristic of metal by artificially forming periodic metal patterns over a substrate composed of a dielectric and others. This is called an artificial magnetic conductor (AMC) since a magnetic conductor characteristic which does not naturally exist is implemented over an existing metal conductor. The AMC is also called high impedance surface (HIS) since it has high impedance on its surface. Due to the high impedance on the surface, a bandgap is generated in a specific band. The generated bandgap reduces a surface current to suppress an occurrence of surface waves. However, the EBG may not completely suppress the surface current depending on the number of unit cells made of the metal patterns. Moreover, a specific absorption rate (SAR) is bigger than electromagnetic shielding materials.

Meanwhile, these conventional technologies are applied to a fixed position within a radiator when the radiator is designed, and thus, when electromagnetic waves in a finished IT product need to be reduced, applying the technologies to the finished product is difficult.

### SUMMARY OF THE INVENTION

In view of the above, the present invention provides an apparatus for reducing electromagnetic waves and method thereof capable of being simply attached to radiators such as mobile devices and capable of applying in various patterns.

In accordance with one aspect of the present invention there is provided an apparatus for reducing electromagnetic waves, including:

a dielectric layer; and

a plurality of metal unit cells periodically formed over the dielectric layer.

In accordance with another aspect of the present invention there is provided a method for reducing electromagnetic waves, including:

forming an electromagnetic bandgap for reducing a surface current caused by electromagnetic waves radiated from a radiator; and

attaching the electromagnetic bandgap around the radiator.

### BRIEF DESCRIPTION OF THE DRAWINGS

The above features of the present invention will become apparent from the following description of embodiments given in conjunction with the accompanying drawings, in which:

FIG. 1 shows a structure of an apparatus for reducing electromagnetic waves in accordance with an embodiment of the present invention;

FIGS. 2A to 2D illustrate structures of unit cells in an apparatus for reducing electromagnetic waves in accordance with the present invention;

FIG. 3 is a view of an apparatus for reducing electromagnetic waves applied to an inside and outside of a mobile terminal equipped with an embedded antenna;

FIG. 4A illustrates a simulation result of SAR when a mobile terminal except apparatuses for reducing electromagnetic waves is applied to the simulation;

FIG. 4B illustrates a simulation result of SAR when the apparatuses for reducing electromagnetic waves are attached to a mobile terminal and applied to simulation; and

FIG. 5 shows a method for reducing the electromagnetic waves in accordance with the embodiment of the present invention.

### DETAILED DESCRIPTION OF THE EMBODIMENTS

Hereinafter, exemplary embodiments of the present invention will be described in detail with reference to the accompanying drawings.

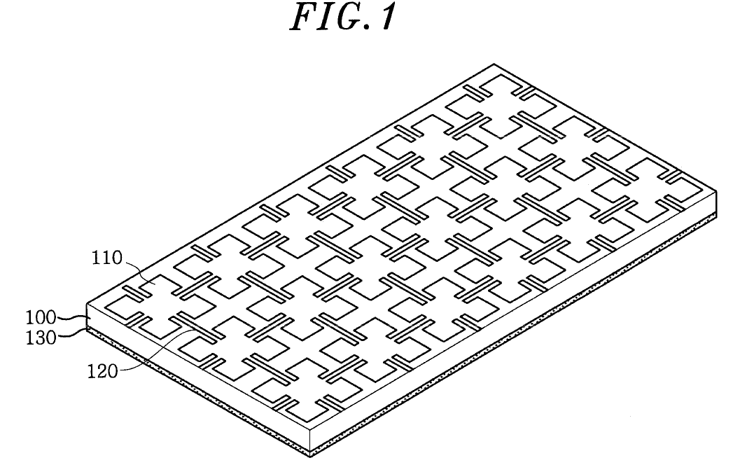

FIG. 1 shows a structure of an apparatus for reducing electromagnetic waves in accordance with an embodiment of the present invention. The apparatus for reducing electromagnetic waves acts as an electromagnetic bandgap (EBG) which reduces a surface current caused by the electromagnetic waves produced from a radiation source. Referring to FIG. 1, the apparatus includes a dielectric 100 and a plurality of metal unit cells 110. The metal unit cells 110 periodically are formed over the dielectric layer 100. A frequency band for operation of the apparatus may be designed by adjusting a distance between the metal unit cells 110. The distance between the metal unit cells 110 is a variable related to a capacitance influencing shielding characteristics of the electromagnetic waves. The metal portion 120 connecting the metal unit cells 110 each other is a variable related to an inductance.

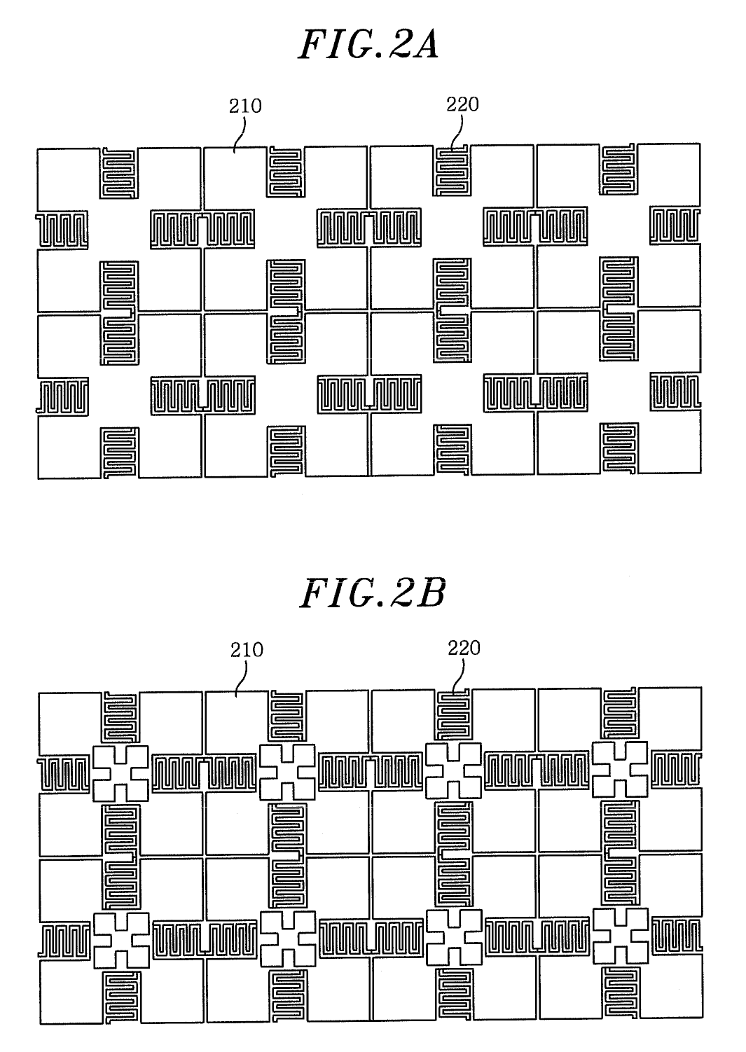

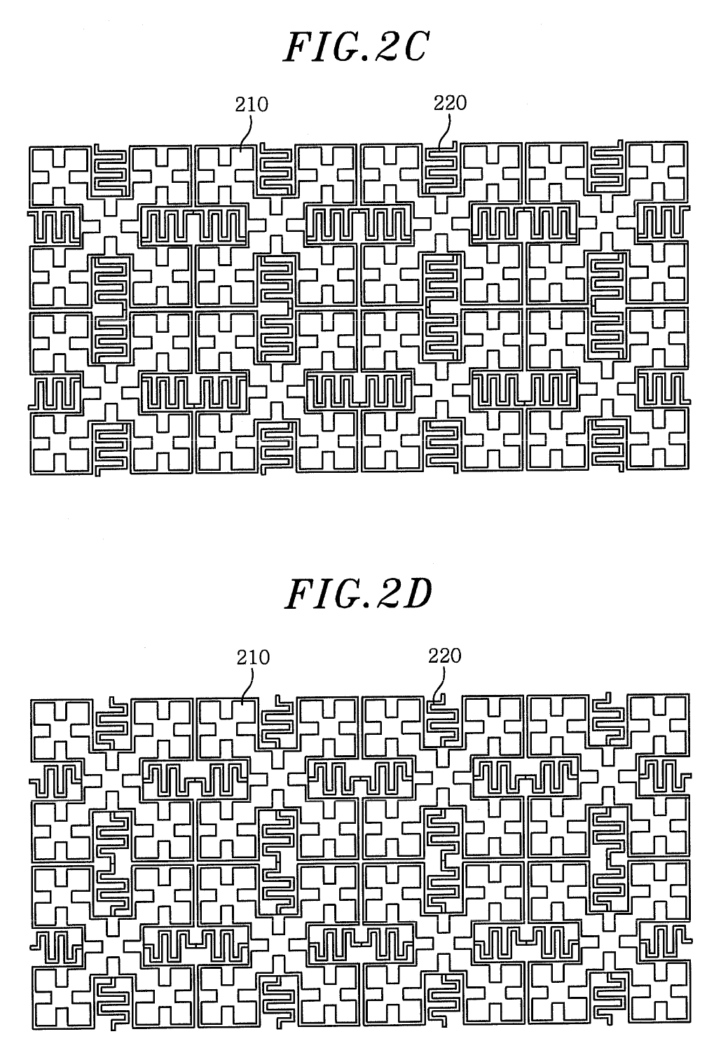

Also, the apparatus for reducing electromagnetic waves may further include an adhesive 130 formed under the dielectric layer 100. The adhesive 130 may be in form of a tape, a film, a glue or the like, depending on places where the apparatus is intended to be attached. The apparatus may directly be attached to radiators using the adhesive 130. FIGS. 2A to 2D illustrate a variety of unit structures in an apparatus for reducing electromagnetic waves in accordance with the present invention.

Referring to FIGS. 2A to 2D, on the apparatus are arranged the unit structures in which adjacent conductors are engaged with each other having a predetermined space therebetween. Each of the unit structures may be formed using a dielectric 210 and a metal patch 220 in various shapes of triangle, quadrangle or fractal.

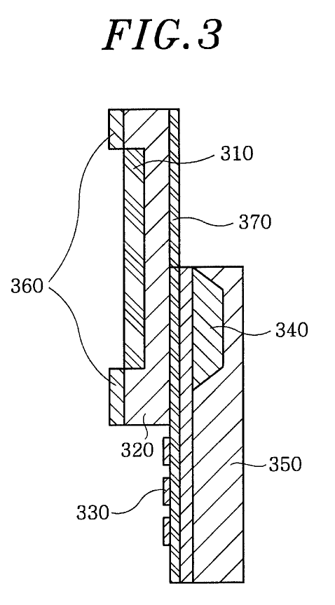

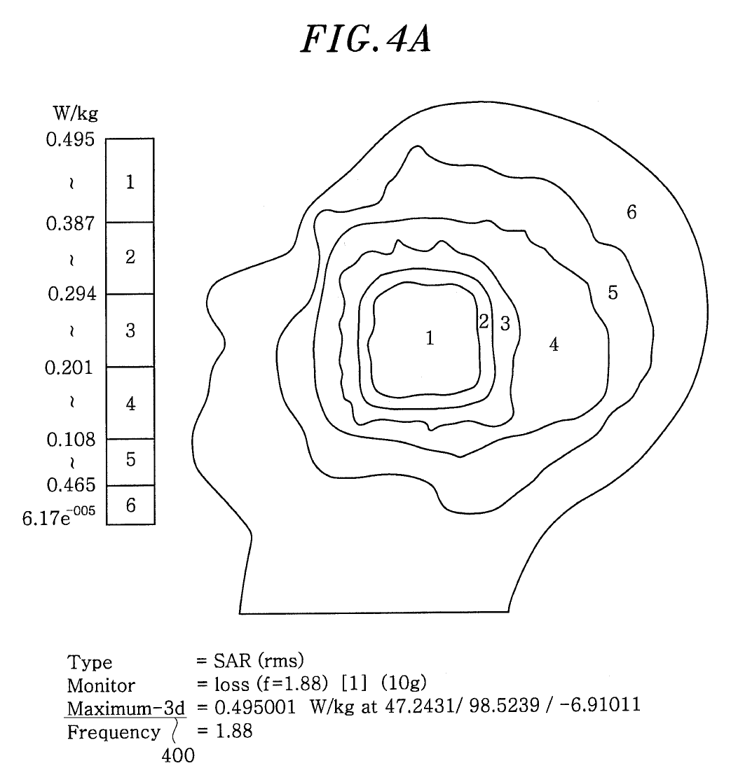

FIG. 3 is a view of an apparatus for reducing electromagnetic waves applied to an inside and outside of a mobile terminal equipped with an embedded antenna. Referring to FIG. 3, the mobile terminal includes a display unit 310, an upper case 320, an antenna 340 which is an electromagnetic radiator, a keypad 330, and a lower case 350. The display unit 310 is inserted in the upper case 320, the antenna 340 is inserted in the lower case 350, and the keypad 330 is attached on the lower case 350.

An apparatus for reducing electromagnetic waves 360 is attached to a front side of the display unit 310 since a human face touches the display unit 310. Also, an apparatus for reducing electromagnetic waves 370 is attached to a rear side of the display unit 310 which is between the antenna 340 and the display unit 310.

Meanwhile, a case of the mobile terminal may act as a dielectric 100, and thus metal unit cells 110 are directly attached to the case of the mobile terminal so as to reduce electromagnetic waves. In addition, if there is a portion made of metal on the case of the mobile terminal, unit cell patterns may be carved on the metal portion, thereby having an effect of reducing electromagnetic waves.

Meanwhile, a simulation of a specific absorption rate (SAR) may be conducted to find out an effect of electromagnetic waves on a human body.

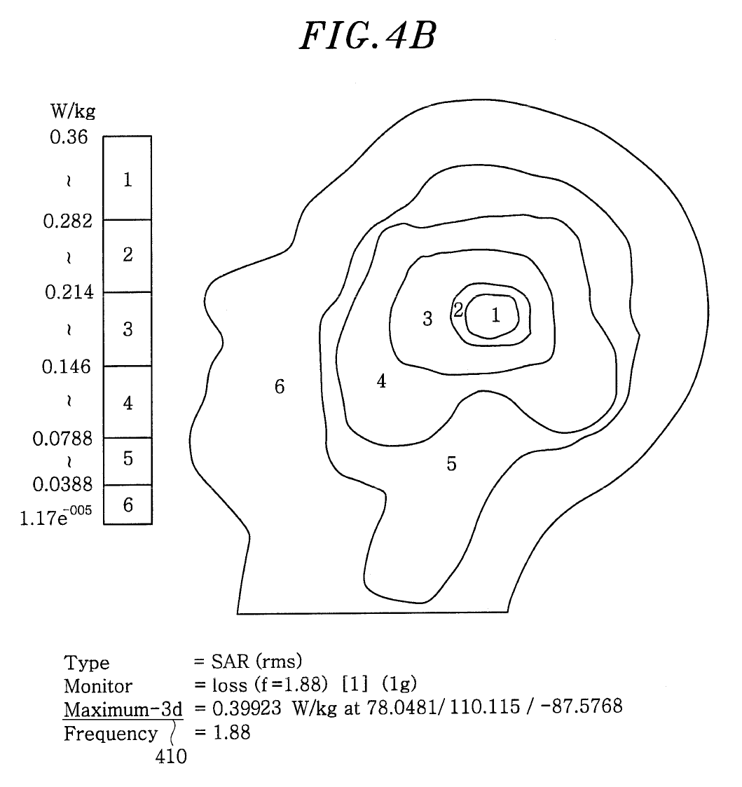

FIG. 4A illustrates the simulation result of SAR when the mobile terminal except apparatuses for reducing electromagnetic waves 360 and 370 shown in FIG. 3 is applied to the simulation. FIG. 4B illustrates the simulation result of SAR when the apparatuses for reducing electromagnetic waves 360 and 370 are attached to the mobile terminal and applied to simulation.

Referring to FIGS. 4A and 4B, the simulations was performed at a frequency 1.88 GHz, which is one of commercial frequency bands of mobile communications. FIG. 4A shows that a mean SAR value 400 is 0.495 per 1 g, and FIG. 4B shows that a mean SAR value 410 is 0.399 per 1 g. Through the simulation result, it is seen that the mean SAR value per 1 g was significantly reduced when the apparatus 360 and 370 were attached to the mobile terminal. Therefore, the present invention brings an effect of protecting a human body from the electromagnetic waves by reducing the electromagnetic waves.

When a surface current is not suppressed by a conventional EBG structure in a limited space such as a mobile device, the surface current may be suppressed by additionally attaching the apparatus of the present invention to a radiator. In this way, the apparatus for reducing electromagnetic waves may be applied to not only a design of a terminal but also a part where a reduction of electromagnetic waves is needed after design, thereby reducing the electromagnetic waves.

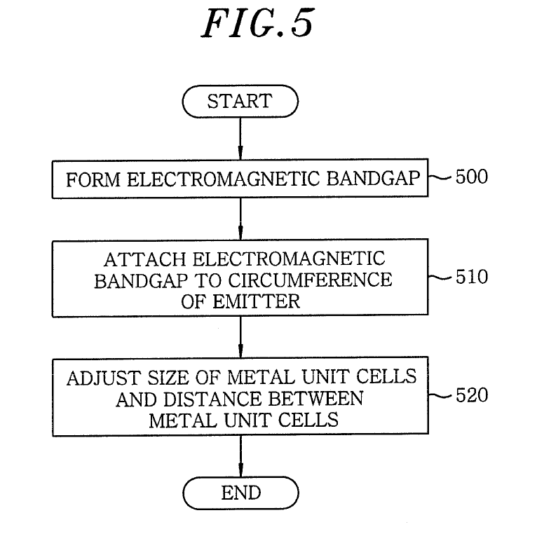

FIG. 5 shows a method for reducing the electromagnetic waves in accordance with the embodiment of the present invention.

Referring to FIGS. 1 to 5, first, an EBG is formed in order to reduce a surface current which occurs by electromagnetic waves radiated from a radiator in step 500. The formed EBG is composed of the dielectric layer 100 and the plurality of metal unit cells 110 periodically formed thereover.

Next, the EBG is attached around the radiator in step 510. A distance between the metal unit cells 110 and a size of the metal unit cells 110 may be adjusted to control an operation frequency band of the electromagnetic bandgap in step 520. Here, the metal unit cells 110 may be formed in a shape of triangle, quadrangle, or fractal.

As described above, while the conventional technologies are only applied to a fixed position within a radiator when the radiator is designed, the present invention may be easily attached not only to IT devices such as mobile terminals but also to devices already using a technology for reducing electromagnetic waves, thereby increasing the reduction effect of electromagnetic waves.

While the invention has been shown and described with respect to the embodiments, it will be understood by those skilled in the art that various changes and modification may be made without departing from the scope of the invention as defined in the following claims.

What is claimed is:

1. An apparatus for reducing electromagnetic waves, comprising:
a dielectric layer; and
a plurality of metal unit cells periodically formed over the dielectric layer.

2. The apparatus of claim 1, further comprising:
an adhesive formed under the dielectric layer for attaching the apparatus to a radiator radiating electromagnetic waves.

3. The apparatus of claim 1, wherein the metal unit cells are formed in any one of shapes of triangle, quadrangle and fractal.

4. The apparatus of claim 1, wherein a distance between the metal unit cells and a size of the metal unit cells are adjusted to determine an operation frequency band of the apparatus.

5. The apparatus of claim 1, wherein the apparatus is attached to a mobile terminal to protect a human body from electromagnetic waves.

6. A method for reducing electromagnetic waves, comprising:
forming an electromagnetic bandgap for reducing a surface current caused by electromagnetic waves radiated from a radiator; and
attaching the electromagnetic bandgap around the radiator.

7. The method of claim 6, wherein the electromagnetic bandgap includes:
a dielectric layer; and
a plurality of metal unit cells periodically formed over the dielectric layer.

8. The method of claim 7, wherein the metal unit cells are formed in any one of shapes of triangle, quadrangle and fractal.

9. The method of claim 7, further comprising:
adjusting a distance between the metal unit cells and a size of the metal unit cells to determine an operation frequency band of the electromagnetic bandgap.

10. The method of claim 6, wherein the electromagnetic bandgap is attached to a mobile terminal to protect a human body from electromagnetic waves.
